(19) United States
(12) Patent Application Publication
(10) Pub. No.: US 2023/0275932 A1
(43) Pub. Date: Aug. 31, 2023

(54) VALIDATION OF SECURITY STANDARD IMPLEMENTATION FOR APPLICATIONS IN PROTECTED EXECUTION ENVIRONMENT

(71) Applicant: VMware, Inc., Palo Alto, CA (US)

(72) Inventors: Marc Wayne BROTHERSON, Boulder, CO (US); Akeem Lamar JENKINS, Broomfield, CO (US)

(73) Assignee: VMware, Inc., Palo Alto, CA (US)

(21) Appl. No.: 17/681,559

(22) Filed: Feb. 25, 2022

(51) Int. Cl. H04L 9/40

(52) U.S. Cl. CPC H04L 63/205; H04L 63/105; H04L 63/1433

(57) ABSTRACT

This application relates generally to validating cybersecurity standard compliance of a computer system within a protected execution environment. An example method includes, obtaining one or more messages from a first component while the first component is operating in a protected execution environment created by applying cybersecurity requirements of a security standard, wherein the one or more messages include information about the cybersecurity requirements, and wherein the one or more messages are encrypted; decrypting the one or more messages; comparing the information contained in the one more messages with corresponding cybersecurity requirements of the security standard for the first component; and determining whether the first component is in compliance with the security standard based on the comparing of the information contained in the one more messages with corresponding cybersecurity requirements of the security standard.

### FIELD

The present disclosure relates generally to validation of security standard implementation, and more specifically, validation of security standard implementation of a computer system within a protected execution environment.

### BACKGROUND

The demand for improvements in cybersecurity measures continues to increase and scale with the increasing ability of processors to break through and defeat traditional security measures. Due to cybersecurity threats from quantum computing, malware, phishing, and the like to secure communications, cybersecurity measures are constantly evolving to protect against evolving cybersecurity threats. Different cybersecurity controls or mechanisms are implemented within computer systems to address risks posed by the cybersecurity threats. Security standards, such as a Security Technical Implementation Guide (STIG), provide a common approach for maintaining security for a computer system. To ensure compliance with a security standard, the computer system is often audited to check its security standard implementation against requirements of the security standard. However, after a computer system has been secured in accordance with the security standards, the protected execution environment of the computer system may prevent an outside administrator or auditor from validating the security standard implementation.

### SUMMARY

This application describes intelligently auditing security standard compliance of a computer system within a protected execution environment without compromising the security of the system.

A computer implemented method for cybersecurity validation within a client computing environment includes the following: obtaining one or more messages from a first component while the first component is operating in a protected execution environment created by applying cybersecurity requirements of a security standard, wherein the one or more messages include information about the cybersecurity requirements, and wherein the one or more messages are encrypted; decrypting the one or more messages; comparing the information contained in the one more messages with corresponding cybersecurity requirements of the security standard for the first component; and determining whether the first component is in compliance with the security standard based on the comparing of the information contained in the one more messages with corresponding cybersecurity requirements of the security standard.

A non-transitory computer-readable storage medium that stores instructions configured to be executed by one or more processors of an electronic device is disclosed. The instructions include: obtaining one or more messages from a first component while the first component is operating in a protected execution environment created by applying cybersecurity requirements of a security standard, wherein the one or more messages include information about the cybersecurity requirements, and wherein the one or more messages are encrypted; decrypting the one or more messages; comparing the information contained in the one more messages with corresponding cybersecurity requirements of the security standard for the first component; and determining whether the first component is in compliance with the security standard based on the comparing of the information contained in the one more messages with corresponding cybersecurity requirements of the security standard.

An electronic device is disclosed and includes one or more processors; and memory storing one or more programs configured to be executed by the one or more processors, the one or more programs including instructions for: obtaining one or more messages from a first component while the first component is operating in a protected execution environment created by applying cybersecurity requirements of a security standard, wherein the one or more messages include information about the cybersecurity requirements, and wherein the one or more messages are encrypted; decrypting the one or more messages; comparing the information contained in the one more messages with corresponding cybersecurity requirements of the security standard for the first component; and determining whether the first component is in compliance with the security standard based on the comparing of the information contained in the one more messages with corresponding cybersecurity requirements of the security standard.

Other aspects and advantages of the invention will become apparent from the following detailed description taken in conjunction with the accompanying drawings, which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 shows a block diagram illustrating an exemplary client computing environment implementing security standard validation for an application, in accordance with the described embodiments.

FIG. 2A shows a block diagram illustrating an exemplary client computing environment implementing security standard validation for multiple applications, in accordance with the described embodiments.

FIG. 2B shows exemplary steps for implementing security standard validation for multiple applications, in accordance with the described embodiments.

FIG. 2C shows exemplary security requirements of a security standard, in accordance with the described embodiments

FIG. 3 shows a block diagram illustrating an exemplary client computing environment implementing security standard validation using a blockchain, in accordance with the embodiments described herein.

FIG. 4 shows a block diagram illustrating an exemplary client computing environment implementing security standard validation using a blockchain outside the client computing environment, in accordance with the embodiments described herein.

FIG. 5 shows a block diagram illustrating an exemplary client computing environment implementing security standard validation using first and second blockchains, in accordance with the embodiments described herein.

FIG. 6 shows a flow diagram illustrating a process in validating security standard compliance for a computer system, in accordance with the embodiments described herein.

FIG. 7 shows a flow diagram illustrating a process in validating security standard compliance for a computer system, in accordance with the embodiments described herein.

### DETAILED DESCRIPTION

Certain details are set forth below to provide a sufficient understanding of various embodiments of the invention. However, it will be clear to one skilled in the art that embodiments of the invention may be practiced without one or more of these particular details. Moreover, the particular embodiments of the present invention described herein are provided by way of example and should not be used to limit the scope of the invention to these particular embodiments. In other instances, hardware components, network architectures, and/or software operations have not been shown in detail in order to avoid unnecessarily obscuring the invention.

Cyber-attacks are a constant threat to computer systems such as network devices, software, databases, cloud infrastructures, operating systems, and the like. Security standards defined by different institutions provide baseline security configuration guidance for securing computer systems. Different institutions such as the Defense Information Security Agency (DISA), the National Institute of Standards and Technology (NIST) SP 800-53, the Cybersecurity Maturity Model Certification (CMMC), and Risk Management Framework (RMF) define various security standards for different computing environments. Computer systems implementing and complying with these security standards mitigates a risk of cybersecurity breaches and intrusions to the systems.

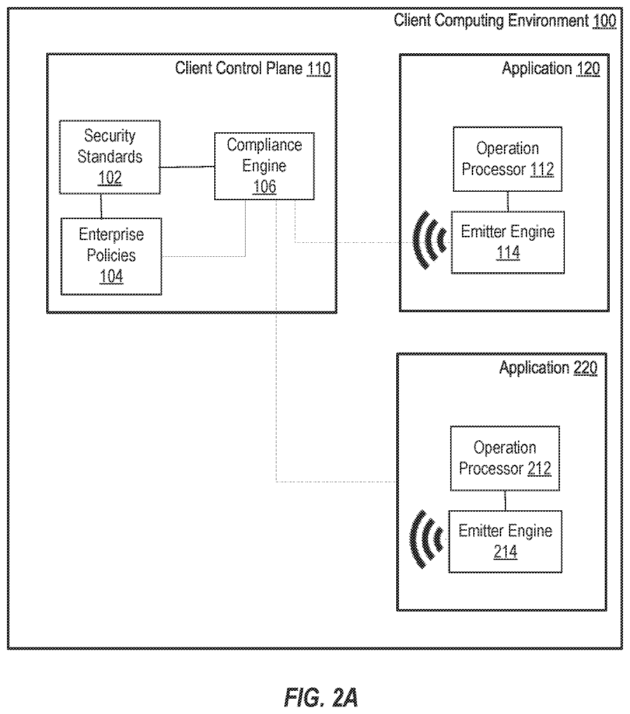

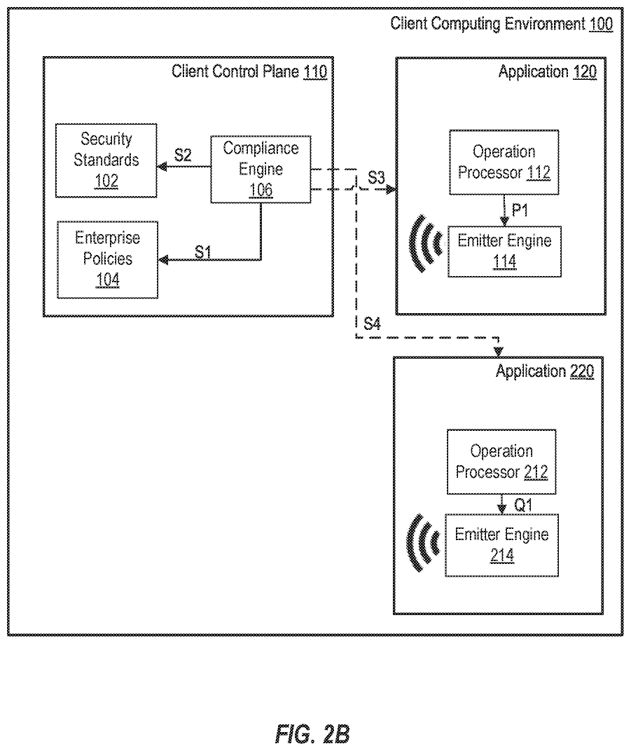

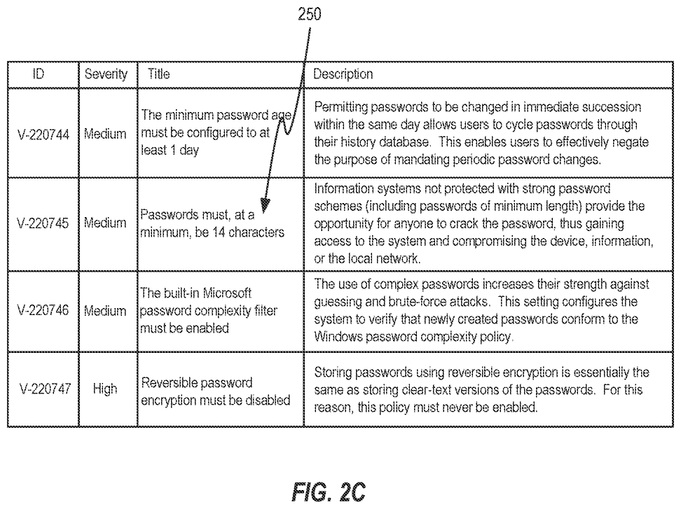

A Security Technical Implementation Guide (STIG) is a security standard developed by Defense Information Security Agency (DISA). A STIG is a security standard that specify cybersecurity requirements to secure computer systems that might otherwise be vulnerable to security issues. For example, a STIG may provide configuration guidance for network devices, software, databases, and operating systems to strengthen baseline security configurations for these systems. STIGs provide security standards for a range of solutions for securing networks, software and devices. A STIG standard may consist of controls, requirements and policies for securing one or more networks, software and devices. An example of the STIG standard is further described in FIG. 2C description.

Typically, a STIG standard implemented on a computer system may enable the computer system to create a protected execution environment to secure itself from outside influence or vulnerabilities in order to protect the computer system. The STIG standard may provide cybersecurity requirements to lock down information, systems, and software, which might otherwise be vulnerable to a malicious computer attack by limiting account access to a system. To ensure compliance with a STIG standard, a computer system is often audited to check its STIG implementation against security requirements of the STIG standard.

To assess STIG implementation of a secured computer system, an outside administrator or auditor may manually check security controls or measures against STIG requirements by unsealing or unlocking the computer system. To manually assess STIG compliance, an auditor may go through each STIG security requirement one by one and test each security control or mechanism within the system against the security requirement. While a STIG implementation may require a computer system to be secured or isolated from the outside world, validating the STIG implementation may require breaching the STIG implementation.

Further, manually checking each security control or mechanism of a computer system may require a user or an organization to spend a considerable amount of time while potentially compromising security of the computer system. The present embodiments enable assessment of security standard (e.g., STIG) implementation without compromising security of a computer system on a protected execution environment. In addition, the present embodiment allows the external system to assess STIG implementation of a computer system running in a protected execution environment without interruptions while the computer system is performing one or more operations.

As discussed in the present embodiments, an administrator or auditor assessing a security standard (e.g., STIG) implementation of a computer system may detect messages or metadata emitted from the computer system after the computer system has been secured in accordance with cybersecurity requirements of the security standard to create a protected execution environment. The messages may also be emitted from the computer system while the computer system is performing one or more operations within the protected execution environment. The messages emitted from the computer system are encrypted using a predefined authentication scheme. The administrator or auditor determines the cybersecurity requirements associated with the security standard for the computer system, decrypts the messages, and determines security standard compliance of the computer system based on the security requirements and information from the messages. The present disclosure improves the cybersecurity of a computer system by evaluating the computer system's security standard implementation without compromising the protected execution environment of the computer system. While the example of a STIG standard is used in an exemplary manner, it should be appreciated that other types of security standards such as CIS benchmarks can also be monitored for compliance using the embodiments disclosed herein.

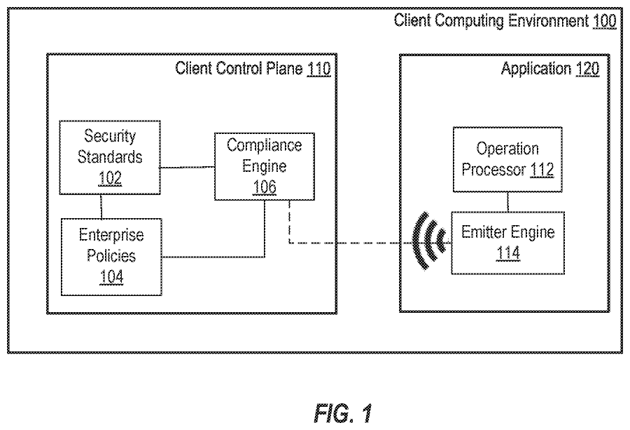

These and other embodiments are discussed below with reference to FIGS. 1-6. Those skilled in the art, however, will readily appreciate that the detailed description given herein with respect to these figures is for explanatory purposes only and should not be construed as limiting.

FIG. 1 shows a block diagram illustrating an exemplary client computing environment implementing security standard validation for an application, in accordance with the described embodiments. FIG. 1 depicts one or more processes implementing a client computing environment 100. In some examples, the client computing environment 100 may include a desktop computer, a mobile telephone or smartphone, a personal digital assistant (PDA), a laptop computer, a tablet computer or combination of one or more computing devices. In some examples, a client computing environment 100 includes a computing device (or a server device) in communication with one or more computing devices via a communications network (e.g., local area networks (LAN) or wide area networks (WAN), e.g., the Internet).

In some examples, the client computing environment 100 may include an application (or a computer system) 120. In the above examples, the application may be a hardware processor, cloud-based web service, network application, database, cloud infrastructure, a computing environment hosted on a server, or any type of software application performing one or more operations. For example, application 120 may be an authentication application that takes one or more inputs from a user and authenticates the user. In some examples, the application 120 may interact with at least one server(s) or other computing device(s) over a communications network. The application 120 may communicate with other computing device(s) or servers (e.g., client control plane 110) over a network directly or indirectly via any suitable intermediate device(s) or network(s). For example, the application 120 may communicate via one or more cellular base stations or one or more wireless access points such as IEEE 803.11.

In some examples, a server hosting the application 120 may be any type of known computer, server, or data processing device. The server may further include RAM, ROM, network interface, input/output interfaces, and memory. The one or more processors (e.g., 112) may reside on a server hosting the application 120 or on a different device or a server connected to the application 120 through the network, via direct or indirect connection or some other network. In some examples, the application 120 may be installed on a client device or is accessible from the client device using a web browser.

In some examples, application 120 may implement cybersecurity requirements of a security standard, such as a STIG standard. Accordingly, application 120 may use one or more security controls or mechanisms specified by the security standard while performing one or more operations. For example, application 120 may be an accounting software that provides an access to a user's account. The application 120 implementing the security standard may be required to comply with security measures or controls specified by one or more security requirements of the security standard. For example, one of requirements of a STIG standard may require the application 120 to enforce a minimum of a 14-character password length. Accordingly, an application implementing the security standard may require every user to create a password that is at least 14-character long.

In the above examples, the application 120 implementing the security standard is configured to execute within a protected execution environment. A protected execution environment may guarantee code and data loaded inside the application 120 is to be protected with respect to confidentiality and integrity. In some examples, the protected execution environment precludes external access to the application 120 sufficient to validate the compliance of the application 120 to the security standards. Additional examples of protected execution environments may include software and hardware attestation methodologies, such as TPM module on a motherboard, software supply chain attestation from a build pipeline, SGX attestation, a secure enclave computing environment, etc. In the above example, operations associated with the application 120 may be performed by the operation processor 112.

In the above examples, processor 112 may execute a set of instructions or code to perform one or more operations (e.g., log-in operation) for the application 120. The processor 112 may execute microcode or additional instructions at the end of each operation or set of operations. The execution of microcode may enable emitter engine 114 to emit metadata or information related to the one or more operations performed by the processor 112 or configuration of the application 120. In some example, the microcode may be installed prior to the creation of the protected execution environment on application 120. While a specific example of microcode is provided, it should be appreciated the described embodiments can be implemented in other ways, including the use of an agent or a daemon running on processor 112.

In some examples, the emitter engine 114 may transmit the metadata at a predefined frequency or on a particular channel or series of channels (e.g., Wifi or Bluetooth frequency channel). The metadata may provide information pertaining to STIG implementation of the application 120. For example, to show compliance with password minimum character requirement, emitter engine 114 may emit character requirement for a user's password. In some examples, emitter engine 114 may use a specific API for emitting the metadata.

In some examples, emitter engine 114 may create one or more messages that includes metadata and emit the messages to a predefined frequency channel. The one or more messages may not be addressed to any specific destination (e.g., IP address using IPv4 or IPv6 protocol format). Emitter engine 114 simply transmits the metadata to a specific frequency. In some examples, the messages may be beacon messages. For example, the emitter engine 114 may emit the metadata in the form of beacon messages on a periodic basis without being prompted by an external request. In some examples, engine 114 may emit the metadata while processor 112 is performing one or more operations (e.g., log-in operation).

In the above examples, the emitter engine 114 may encrypt the metadata using a predefined authentication scheme prior to emitting the metadata in the form of messages. In some examples, emitter engine 114 may encrypt the metadata or messages containing metadata using a private key. In some examples, messages may be encrypted with pre, hybrid, or post quantum encryption methodologies only readable by the control plane 110 (or compliance engine 106). While not depicted in FIG. 1, in some embodiments, a compliance engine can be established generally outside of client control plane 110 or client computing environment 100 and configured to confirm compliance of one or more applications by monitoring metadata emitted wirelessly by emitter engine(s) 114 and/or 214

In some examples, client computing environment 100 may include enterprise policies 104. Enterprise policies 104 may include a list of cybersecurity policies for an organization. In some embodiments, enterprise policies 104 may include one or more cybersecurity policies including policies involving one or more STIG standards for the organization. For example, an example policy within the policies 104 may require that application 120 or certain operations within the application 120 may comply with a specific STIG standard. The policy may also require that the application 120 may follow additional cybersecurity measures in addition to complying with the STIG standard. For example, a STIG standard may require the application 120 to enforce minimum 15-character password requirement. An enterprise policy within policies 104 may also provide that application 120 require a specific number of letters, numbers and/or special characters in a password. In some examples, enterprise policies 104 may be a table or database mapping one or more policies to one or more applications within the computing environment 100.

In some examples, client computing environment 100 may include a latest version of security standards 102 applicable for applications within the client computing environment 100. In some examples, security standards 102 may include a STIG standard. As discussed, the STIG standard may provide technical guidance to secure one or more applications within the computing environment 100. Security standards 102 may specifically provide configuration guidance (e.g., STIG standard) specifically for application 120 to strengthen baseline security configuration for the application 120. For example, if the application 120 is specific to managing network devices then the security standards 102 may provide a security standard associated with securing network elements such as firewalls, routers, server configurations, and the like for the application 120.

In some examples, the security standards 102 may be updated periodically or at a predetermined time when security standards (or requirements within the security standards) are updated by the agency maintaining the security standards. In some examples, security standards 102 may simply provide a link to a latest version of security standards for the application 120. In some examples, a processor associated with security standards 102 may obtain security standards from institution(s) creating the standards (e.g., DISA website). Security standards may be obtained as an *.xsl, *.xml, *.pdf, or a *.zip file.

In some examples, client computing environment 100 may include a compliance engine 106 for determining security standard implementation for the application 120. The compliance engine 106 may retrieve messages emitted by engine 114 to assess compliance of the application 120 with one or more security standards. In some examples, in order to assess the compliance of application 120, the engine 106 may obtain one or more enterprise policies for the application 120 from the enterprise policies 104. Further the compliance engine 106 may access cybersecurity requirements associated with security standards based on policies retrieved from policies 104. For example, a policy within enterprise policies 104 may indicate that an application 120 must comply with a specific version of STIG standard. Upon retrieving such policy, the engine 106 may obtain the specific version of STIG standard from security standards 102. Specifically, the engine 106 may obtain one or more security requirements associated with the STIG standard from security standards 102.

In some examples, client computing environment 100 includes a client control plane 110, as shown in FIG. 1. The control plane 110 is responsible for controlling data traffic of the client computing environment. In some examples, the control plane may include components such as a security standard 102, policies 104, and a compliance engine 106 for assessing security standard implementations of application(s) within the computing environment 100, as shown in FIG. 1.

In the above examples, the compliance engine 106 may further evaluate messages received from the emitter engine 114. Specifically, the engine 106 may evaluate metadata from engine 114 in view of one or more requirements associated with a security standard for the application 120. For example, for an application performing a log-in operation, a security standard requirement may require that a minimum password character requirement is enforced by the application. Messages from emitter engine 114 may include user's password requirements for log-in sessions. The compliance engine 106 may evaluate whether the minimum character requirement is met based on the received metadata. Accordingly, the compliance engine 106 may determine whether the application 120 is complying with the password security requirement for a security standard without interrupting with any operations of the application 120. Additional scenarios and examples of assessing security standard compliance of multiple applications are described in FIG. 2A-6.

FIG. 2A shows a block diagram illustrating an exemplary client computing environment implementing security standard validation for multiple applications, in accordance with the described embodiments. As discussed in FIG. 1, the client computing environment 100 may include security standards 102, enterprise policies 104 and compliance engine 106 to evaluate security standard compliance of the application 120 within the computing environment 100. As shown in FIG. 2A, the client computing environment 100 may also include another application (or computer system) 220.

In the above examples, the application 220 may be a hardware processor, cloud-based web service, network application, database, cloud infrastructure, or any type of software application performing one or more operations. For example, application 220 may be an authentication application that takes one or more inputs from a user and authenticates the user. In some examples, the application 220 may interact with at least one server(s) or other computing device(s) over a communications network. The application 220 may communicate with other computing device(s) or servers (e.g., client control plane 110) over a network directly or indirectly via any suitable intermediate device(s) or network(s). For example, the application 220 may communicate via one or more cellular base stations or one or more wireless access points such as IEEE 803.11. The application 220 may be a web application, a computing environment hosted on a server, or a data file on a server.

In some examples, a server hosting the application 220 may be any type of known computer, server, or data processing device. The server may further include RAM, ROM, network interface, input/output interfaces, and memory. The one or more processors may reside on a server hosting the application 220 or on a different device or a server connected to the application 220 through the network, via direct or indirect connection or some other network. In some examples, the application 220 may be installed on a client device or is accessible from the client device using a web browser.

In some examples, similar to the application 120, application 220 may also implement a security standard such as a STIG standard. Application 220 may use one or more security controls or mechanisms specified by the STIG standard while performing one or more operations. For example, application 220 may be an accounting software that provides access to a user's account. The application 220 implementing the STIG standard may be required to comply with security measures or controls specified by one or more security requirements of the STIG standard. For example, one requirement of a STIG standard may enforce a minimum of 14-character password length for application 220. Accordingly, an application implementing the STIG standard may require every user to create a password having at least 14-characters. In another example, the STIG standard may also require the closure of one or more communication ports that would normally be made available in a conventional configuration. In particular, the STIG standard can require disabling the SSH communication port in systems where leaving the SSH port enabled is deemed to introduce too much risk. Unfortunately, disabling the SSH port can make running diagnostics and verifying compliance of a particular computing system much more difficult and in certain cases impossible.

In the above examples, the application 220 implementing a security standard is configured to execute within a sealed off or protected execution environment. A protected execution environment guarantees code and data loaded inside the application 220 is to be protected with respect to confidentiality and integrity. In the above example, operations associated with the application 220 may be performed by operation processor 212.

In the above examples, operation processor 212 may execute a set of instructions or code to perform one or more operations (e.g., a log-in operation) for the application 220. Operation processor 212 may execute microcode or instructions at the end of each operation or set of operations. The execution of microcode may enable emitter engine 214 to emit metadata or information related to the one or more operations performed by the processor 212. In some examples, the emitter engine 214 may transmit the metadata or information to a predefined frequency channel (e.g., WiFi, Bluetooth frequency channels or other wireless protocols). The metadata may provide information pertaining to STIG compliance of the application 220. For example, to show compliance with password minimum character requirement, emitter engine 214 may emit character information about a user's password.

In some examples, engine 214 may use a specific API for emitting the metadata. In the above examples, emitted metadata within messages are not addressed to any specific destination (e.g., IP address). Emitter engine 214 simply transmits the metadata on a specific frequency. In some examples, the emitter engine 214 may emit the metadata in form of messages on a periodic basis. In some examples, engine 214 may emit the metadata while processor 212 is performing one or more operations (e.g., log-in operation). In the above examples, the emitter engine 214 may encrypt the metadata using a predefined authentication scheme prior to emitting the metadata in the form of messages. In some examples, emitter engine 214 may encrypt the metadata or messages containing metadata using a private key.

In the above embodiments, enterprise policies 104 may include one or more security policies including policies involving one or more security standards for the organization, as described in FIG. 1 description. For example, an example policy within the policies 104 may require that application 220 or a certain operations within the application 220 may comply with a specific security standard. The policy may also require that the application 220 may follow additional security measures in addition to complying with the security standard. For example, a security standard may require the application 220 to enforce minimum 14-character password requirement. An enterprise policy within policies 104 may also provide that application 220 require a specific number of letters and numbers in a password.

In some examples, client computing environment 100 may include a latest version of security standards 102 applicable for applications within the client computing environment 100. Security standards 102 may specifically provide configuration guidance (e.g., STIG standard) specifically for application 220 to strengthen baseline security configuration for the application 220. For example, if the application 220 is specific to managing network devices then the security standards 102 may provide a security standard associated with securing network elements such as firewalls, routers, server configurations, and the like for the application 220. In some examples, security standards 102 may simply provide a link to a latest version of security standards for the application 220.

In some examples, client computing environment 100 may include a compliance engine 106 for determining security standard compliance for the application 220. The compliance engine may retrieve metadata emitted by engine 214 to assess compliance of the application 220 with one or more security standards. In some examples, in order to assess the compliance of application 220, the engine 106 may obtain one or more enterprise policies for the application 220 from the enterprise policies 104. Further the compliance engine 106 may access requirements associated with one or more standards based on policies retrieved from policies 104. For example, a policy within enterprise policies 104 may indicate that an application 220 must comply with a specific version of STIG standard. Upon retrieving such policy, the engine 106 may obtain the specific version of STIG standard from security standards 102. Specifically, the engine 106 may obtain one or more security requirements associated with the STIG standard from security standards 102.

In the above examples, the compliance engine 106 may further evaluate metadata received from the emitter engine 214. Specifically, engine 106 may evaluate metadata from engine 214 in view of one or more requirements associated with a security standard for the application 220. For example, for an application performing a log-in operation, a security standard requirement may require that a minimum character requirement is enforced by the application. Metadata from engine 214 may include a user's password requirements for log-in sessions. The compliance engine 106 may evaluate whether the minimum character requirement is met based on the received metadata. Accordingly, the compliance engine 106 may determine whether the application 220 is complying with one or more security requirements for a security standard without interrupting any operations or the application 220. Accordingly, the compliance engine 106 may assess security standard compliance for both applications 120 and 220.

FIG. 2B shows exemplary steps for implementing security standard validation for multiple applications, in accordance with the described embodiments. As discussed in FIGS. 1 and 2A, the compliance engine 106 may assess security standard compliance of multiple applications within the client computing environment 100. In some examples, the compliance engine 106 may perform steps S1 to S4 (described in detail below) to assess security standard implementations of applications 120 and 220. In some examples, the compliance engine 106 may perform steps S1-S4 on periodic basis to check the compliance of security standard implementations on applications 120 and 220. In other examples, the compliance engine 106 may perform steps S1-S4 upon receiving a request from a processor within the client computing environment 100 or outside the environment 100 to check for compliance of applications 120 and 220.

In step S1, the compliance engine 106 may obtain policies for the applications 120 and 220. In some examples, the compliance engine 106 may specifically obtain all the policies specific to applications 120 and 220. Alternatively, the compliance engine 106 may obtain policies associated with one or more operations performed by the applications 120 and/or 220 or configurations of elements associated with the applications 120 and/or 220.

In step S2, the compliance engine 106 may obtain security requirements associated with one or more security standards based on policies for the applications 120 and 220. In some examples, the compliance engine 106 may specifically obtain security requirement files from a database associated with security standards 102. The security standards 102 may include a database of available security standards for applications 120 and 220. In some examples, in step S2, the compliance engine 106 may provide a link to the latest version of security standards. After obtaining security standards, the compliance engine 106 may determine a list of security controls and mechanisms for applications 120 and 220. The compliance engine 106 may determine a method for assessing security controls or mechanisms for applications 120 and 220 based on security requirements associated with security standards. For example, a security requirement may require that application 120 follows a certain password requirement. Compliance engine 106 may inspect metadata from application 120 to check for password requirements. In some examples, the compliance engine 106 may create a command and test the metadata using the command to check if certain passwords are accepted.

In steps S3 and S4, the compliance engine 106 may obtain metadata (or messages containing metadata) emitted by applications 120 and 220. In some examples, the compliance engine may constantly monitor for messages or metadata emitted from the applications 120 and 220 at predefined frequency channels and gather messages emitted by applications 120 and 220. In some examples, may monitor and obtain metadata provided by applications 120 and 220 on a periodic basis. Alternatively, the compliance engine 106 may obtain metadata (or messages containing metadata) emitted by applications 120 and 220 in response to receiving a request for assessing security standard compliance. In the above examples, the compliance engine 106 may further evaluate metadata received from the emitter engines 114 and 214 and determine whether the applications 120 and 220 are complying with one or more security requirements for a security standard without interrupting any operations of the applications 120 and 220.

As shown in FIG. 2B, in step P1, operation processor 112 may execute microcode or instructions while performing one or more operations. The execution of microcode may enable emitter engine 114 to emit metadata or information related to the one or more operations performed by the processor 112 or configuration information of application 120. In some examples, operation processor 112 may directly emit the metadata or messages containing metadata to a predefined frequency channel. Alternatively, the operation processor 112 may send the metadata to the emitter engine 114. Emitter engine 114 may generate messages incorporating the metadata and emit the messages to a predefined frequency channel.

As shown in FIG. 2B, in step Q1, the operation processor 212 may execute microcode or instructions while performing one or more operations. The execution of microcode may enable emitter engine 214 to emit metadata (or messages including metadata) related to the one or more operations performed by the processor 212. In some examples, operation processor 212 may directly emit the metadata to a predefined frequency channel. Alternatively, the operation processor 212 may send the metadata to the emitter engine 214. Emitter engine 214 may generate messages incorporating the metadata and emit the messages to a predefined frequency channel.

FIG. 2C shows exemplary security requirements of a security standard, in accordance with the described embodiments. An example security requirements, as shown in FIG. 2C, are associated with a STIG standard developed by DISA. The exemplary security requirements, as shown in FIG. 2C, are for an operating system (e.g., Windows 10, Linux, etc) of a computer system. The security requirements may specifically provide configuration guidance for the operating system to strengthen baseline security configurations for the system. The security requirements may consist of controls, rules, and policies for securing the operating system.

In some examples, a STIG standard may be obtained from an institution creating the STIG standard (e.g., DISA website). It may be obtained as an *.xsl, *.xml, *.pdf, or a *.zip file. As shown in FIG. 2C, a specific policy or requirement 250 for securing the operating system to enforce a minimum of 14-character password length for users of the operating system. Accordingly, an operating system implementing the STIG standard may require every user to create at least a 14-character password.

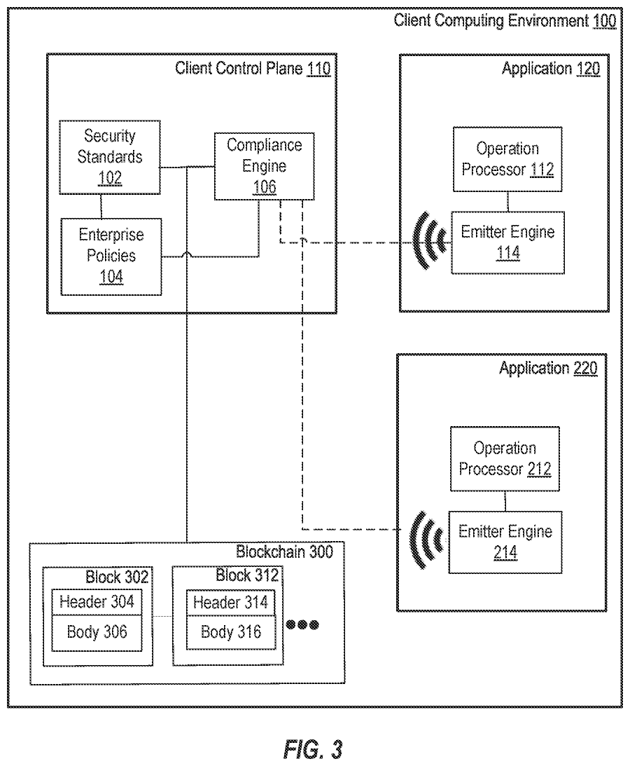

FIG. 3 shows a block diagram illustrating an exemplary client computing environment implementing security standard validation using a blockchain, in accordance with the embodiments described herein. As discussed in FIG. 2A, the client computing environment 100 may include security standards 102, enterprise policies 104 and compliance engine 106 to evaluate security standard implementation of the applications 120 and 220 within the computing environment 100.

In some examples, operation processors (112 and 212) execute microcode or instructions while performing one or more operations. The execution of microcode enables emitter engines (114 and 214) to emit metadata or information related to the one or more operations or configurations continuously in a periodic or aperiodic manner. Emitter engines (114 and 214) may generate messages incorporating the metadata and emit the messages to a predefined frequency channel.

As discussed in FIG. 2A, the compliance engine 106 may specifically obtain the policies specific to applications 120 and 220. The compliance engine 106 may obtain security requirements associated with one or more security standards based on policies for the applications 120 and 220. The compliance engine 106 may obtain metadata (or messages containing metadata) emitted by applications 120 and 220. In the above examples, the compliance engine 106 may further evaluate metadata received from the emitter engines 114 and 214 and determine whether the applications 120 and 220 are complying with one or more security requirements for a security standard without interrupting with any operations or the applications 120 and 220.

In some examples, compliance engine 106 may transmit the determination of compliance to a blockchain 300. In some examples, compliance engine 106 may create a message that includes information about a security standard compliance of an application (e.g., 120 or 220) and transmit the message to the blockchain 300. For example, compliance engine 106 may create a message that simply states whether a specific application (e.g., 120) is in compliance or not in compliance with a security standard. The compliance engine 106 may create a message that further includes information about which security requirements of security standards were not complied by one or more applications (e.g., 120) within the client's computing environment 100.

In some examples, client computing environment 100 may include a blockchain (e.g., a distributed ledger) 300. The blockchain 300 may include one or more blocks (e.g., block 302 and block 312). The blockchain 300 may include an electronic record of one or more compliance determinations for the one or more applications (e.g., 120) within the client computing environment 100. The blocks within the blockchain 300 may be linked where each block may include a reference to the previous block. Each new block in the blockchain 300 may be a latest determination of the compliance of one or more applications within the client computing environment 100.

In some examples, compliance determinations may be stored within blocks of the blockchain as immutable and irreversible transactions to make the blockchain 300 (or distributed ledger) trustworthy. In some examples, a record of compliance determinations may be digitally signed or protected using a private key and stored within blocks of the blockchain in order to protect the record from tampering.

In some examples, each block (e.g., 302, 312, etc.) within the blockchain 300 may include a header and a body. For example, the first block of the blockchain, block 302 may include header 304 and body 306 to store a record of compliance determination. Similarly, block 312 may include header 314 and body 316. The header (e.g., 304) of the block (e.g., 302) may include an identifier of the block. The header of the block may further include information about previous block, a timestamp, and/or any other suitable information. The block body (e.g., 306) may include information stored in the block. For example, a message or record information about compliance determination of applications 120 and 220 may be stored within body 306 of the block 302. Further, when the next compliance determination (e.g., at a later date and/or time) is performed by the engine 106, a message or record information about the compliance determination may be stored within body 316 of block 312.

In some examples, a single block (e.g., block 302) may include a record of compliance determination of all applications (e.g., 120, 220, etc.) within the client computing environment 100. Alternatively, a single block (e.g., block 302) may include a single record of compliance determination for a single application or computer system within the client computing environment. Accordingly, the blockchain 300 includes a series of blocks that includes compliance records for one or more applications running on the client computing environment 100.

In some examples, updates to blockchain 300 may be shared between data centers or ledgers within the client computing environment 100. In the above examples, multiple records of compliance determination can be maintained by a network of blockchains within the client computing environment 100. Accordingly, multiple data centers or systems within the client computing environment 100 synchronize and manage records of compliance of applications within the client computing environment 100 to increase trust, security, and transparency of compliance records.

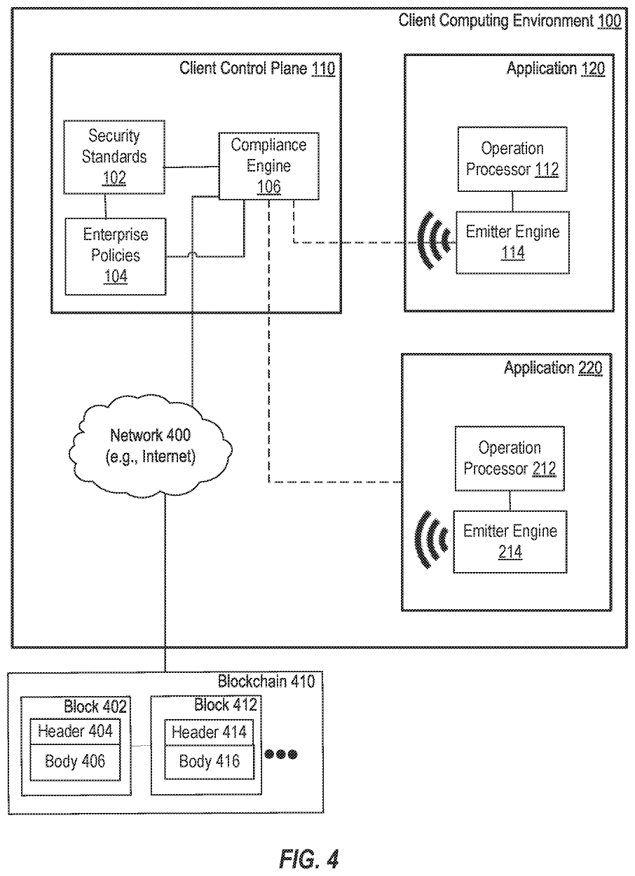

FIG. 4 shows a block diagram illustrating an exemplary client computing environment implementing security standard validation using a blockchain outside the client computing environment, in accordance with the embodiments described herein. As discussed in FIG. 2A, the compliance engine 106 may obtain metadata (or messages containing metadata) emitted by applications 120 and 220, evaluate metadata received from the emitter engines 114 and 214, and determine whether the applications 120 and 220 are complying with one or more security requirements for a security standard without interrupting with any operations or the applications 120 and 220.

In some examples, compliance engine 106 may transmit the determination of compliance to a blockchain 410 through network 400. In some examples, compliance engine 106 may create a message that includes information about a security standard compliance of an application (e.g., 120 or 220) and transmit the message to the blockchain 410. For example, compliance engine 106 may create a message that simply states whether a specific application (e.g., 120) is in compliance with a security standard.

In some examples, the blockchain (e.g., a distributed ledger) 410 may reside on one or more data centers or systems outside the client computing environment. The blockchain 410 may include one or more blocks (e.g., block 402 and block 412). The blockchain 410 may include an electronic record of one or more compliance determination of the one or more applications within the client computing environment 100. The blocks within the blockchain 410 may be linked where each block may include a reference to previous block. Each new block in the blockchain may be a latest determination of compliance.

In some examples, compliance determinations may be stored within blocks of the blockchain as immutable and irreversible transactions to make the blockchain or distributed ledger trustworthy. In some examples, a record of compliance determinations may be digitally signed or protected using a private key and stored within blocks of the blockchain in order to protect the record from tempering.

In some examples, each block (e.g., 402, 412, etc.) within the blockchain 410 may include a header and a body. For example, the first block of the blockchain 410, block 402 may include header 404 and body 406 to store a record of compliance determination. Similarly, block 412 may include header 414 and body 416. The header (e.g., 404) of the block (e.g., 402) may be an identifier of the block. The header of the block may further include information about previous block, a timestamp, and/or any other suitable information. The block body (e.g., 406) may include information stored in the block. For example, a message or record information about compliance determination of applications 120 and 220 may be stored within body 406 of the block 402. Further, when next compliance determination is performed by the engine 106, a message or record information about the compliance determination may be stored within body 416 of block 412. Accordingly, a single block (e.g., block 402) may include a single record of compliance determination of all applications (e.g., 120, 220, etc.) within the client computing environment 100. Accordingly, the blockchain 410 includes a series blocks that includes compliance records for one or more applications running on the client computing environment 100.

In some examples, a block (e.g., 402) may be shared between multiple blockchains or ledgers (e.g., 410) outside the client computing environment 100. In the above examples, multiple records of compliance determination can be maintained by a network of blockchains outside the client computing environment 100, so the records are protected from tampering from a processor within the environment 100. Accordingly, multiple data centers or systems may synchronize and manage records of compliance of applications executing on the client computing environment 100 over a public blockchain external to the environment 100 to increase trust, security, and transparency of compliance records.

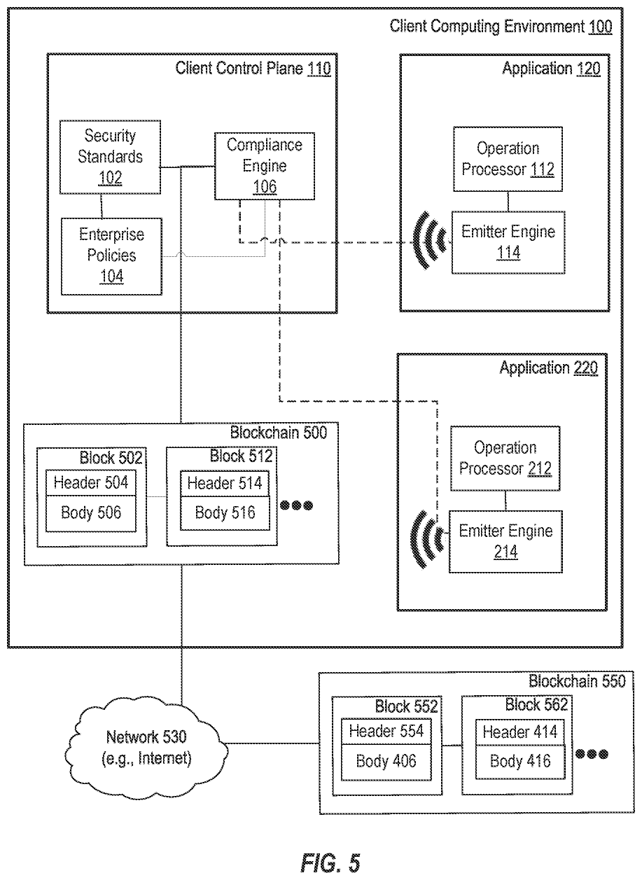

FIG. 5 shows a block diagram illustrating an exemplary client computing environment implementing security standard validation using first and second blockchains, in accordance with the embodiments described herein. As discussed in FIG. 2A, the compliance engine 106 may obtain metadata (or messages containing metadata) emitted by applications 120 and 220, evaluate metadata received from the emitter engines 114 and 214, and determine whether the applications 120 and 220 are complying with one or more security requirements for a security standard without interrupting with any operations or the applications 120 and 220.

In some examples, compliance engine 106 may transmit the determination of compliance to a blockchain 500. In some examples, compliance engine 106 may create a message that includes information about a security standard compliance of an application (e.g., 120 or 220) and transmit the message to the blockchain 500. For example, compliance engine 106 may create a message that simply states whether a specific application (e.g., 120) is in compliance with a security standard. The compliance engine 106 may create a message that further includes information about which security requirements of security standards were not complied by one or more applications within the client's computing environment 100.

In some examples, client computing environment 100 may include a blockchain (e.g., a distributed ledger) 500. The blockchain 500 may include one or more blocks (e.g., block 502 and block 512). The blockchain 500 may include an electronic record of one or more compliance determination of the one or more applications within the client computing environment 100. The blocks within the blockchain 500 may be linked where each block may include a reference to previous block. Each new block in the blockchain may be a latest determination of the compliance.

In some examples, each block (e.g., 502, 512, etc.) within the blockchain 500 may include a header and a body. For example, the first block of the blockchain, block 502 may include header 504 and body 506 to store a record of compliance determination. Similarly, block 512 may include header 514 and body 516. The header (e.g., 504) of the block (e.g., 502) may be an identifier of the block. The header of the block may further include information about previous block, a timestamp, and/or any other suitable information. The block body (e.g., 506) may include information stored in the block. For example, a message or record information about compliance determination of applications 120 and 220 may be stored within body 506 of the block 502.

In some examples, an addition of block to blockchain 500 is submitted to a blockchain 550 outside of the client computing environment 100. The blockchain 550 may be a public blockchain that includes one or more records of security standard compliance from multiple client systems or environments. Blocks (e.g., 552, 562, etc.) of Blockchain 550 may include compliance determination information of applications 120 and 220 similar to blocks of blockchain 500.

In some examples, the blockchain (e.g., a distributed ledger) 550 may reside on one or more data centers or systems outside the client computing environment. In some examples, compliance determinations may be stored within blocks of the blockchain 550 as immutable and irreversible transactions. In some examples, a record of compliance determinations may be digitally signed or protected using a private key and stored within blocks of the blockchain in order to protect the record from tempering.

In some examples, the blockchain 550 includes a series of blocks that includes compliance records for one or more applications running on the client computing environment 100 as well as other applications running on other computing environments. Accordingly, a single block 552 of blockchain 550 may include information of block 502 of blockchain 500. However, the block 562 of blockchain 550 may include compliance information about a different application or system outside of the client computing environment 100. In the above examples, multiple records of compliance determination can be maintained by a network of blockchain both within and outside the client computing environment 100, so the records are protected from tampering. Accordingly, multiple data centers or systems may synchronize and manage records of compliance of applications executing on the client computing environment 100 over multiple blockchains to increase trust, security, and transparency of compliance records.

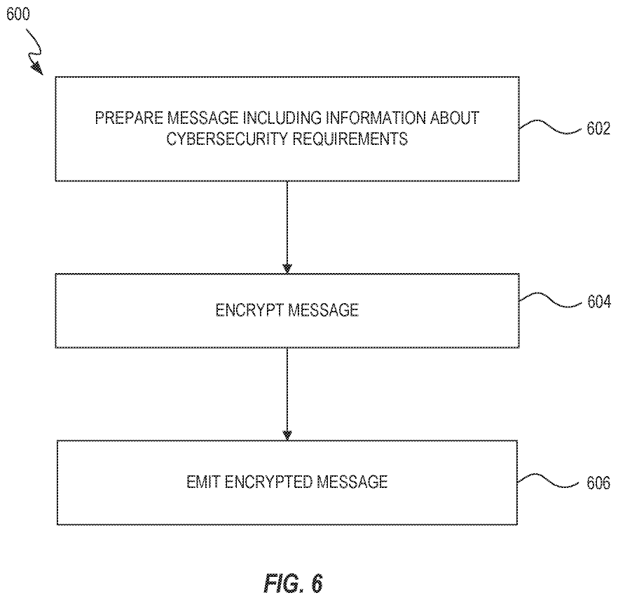

FIG. 6 shows a flow diagram illustrating a process performed in determining security standard compliance for a computer system, in accordance with the embodiments described herein. In some examples, a process 600 is performed, for example, by one or more electronic devices within client computing environment 100.

In some examples, in step 602, a first component (e.g., application 120) prepares a message that includes information about one or more cybersecurity requirements of a security standard. As discussed above, the cybersecurity requirements of the security standard were applied to create a protected execution environment on the first component. For example, the cybersecurity requirements for the first component may include controls, requirements and policies for securing the first component (e.g., software or hardware device) or securing operations performed by the first component.

In some examples, in step 604, the first component may encrypt the message using a predefined authentication scheme. For example, the messages may be encrypted using a private key by the first component.

In some examples, in step 606, the encrypted message is emitted from the first component. In some examples, the message is a beacon message, which is emitted on a predefined schedule without being prompted.

In some examples, in process 600, the security standard is a Security Technical Implementation Guide (STIG). In some examples, process 600 is performed by executing microcode. In some examples, the microcode was installed on the first component before the cybersecurity requirements were applied.

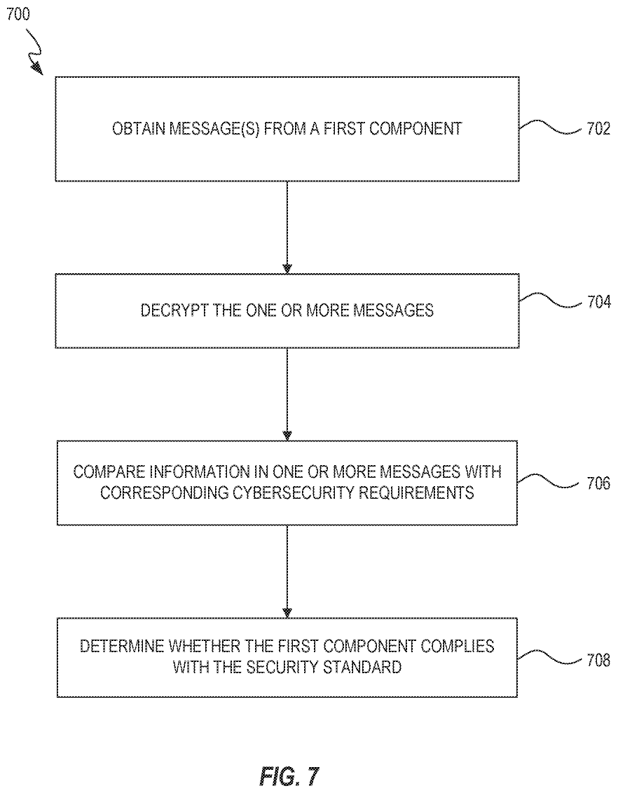

FIG. 7 shows a flow diagram illustrating a process performed in determining security standard compliance for a computer system, in accordance with the embodiments described herein. In some examples, a process 700 is performed, for example, using one or more electronic devices implementing client computing environment 100. In some examples, one or more blocks of process 700 are performed by one or more remote servers, one or more local servers, a cloud computing system, and/or the like. Alternatively, the one or more blocks of process 700 are performed by the one or more client electronic devices within the client computing environment 100. For example, the blocks of process 700 are divided up in any manner between one or more servers and a client device. Thus, while portions of process 700 are described herein as being performed by particular devices, it will be appreciated that process 700 is not so limited.

In another example, the process 700 is performed using only a client device (e.g., control plane 110) or multiple client devices or computing processors. In process 700, some blocks are, optionally, combined, the order of some blocks is, optionally, changed, and some blocks are, client devices, optionally, omitted. In some examples, a client computing environment 100 may include one or more processors (e.g., compliance engine 106) in communication with a different computing device via a communications network (e.g., local area networks (LAN) or wide area networks (WAN), e.g., the Internet).

In some examples, in step 702, one or more processors (e.g., compliance engine 106) within the client computer environment 100 may obtain one or more messages from a first component (e.g., application 120) while the first component is operating in a protected execution environment created by applying cybersecurity requirements of a security standard.

As described above, in some examples, the one or more messages include information about one or more cybersecurity requirements associated with the first component. In some examples, the one or more cybersecurity requirements of the security standard were applied to create the protected execution environment on the first component. In some examples, the one or more messages were beacon messages that are emitted from the first component on a predefined schedule without being prompted.

As described above, in some examples, the obtained one or more messages were encrypted by the first component using a predefined authentication scheme. Thus, in some examples, in step 704, the one or more processors may decrypt the one or more messages using the predefined authentication scheme. In some examples, the messages were encrypted using a private key by the first component. Accordingly, in step 704, the one or more processors may decrypt the messages using the private key.

In some examples, in step 706, the one or more processors may compare the information included in the one or more messages from the first component with corresponding cybersecurity requirements of the security standard for the first component. As described above, the cybersecurity requirements are associated with the security standard applied to create the protected execution environment on the first component. For example, the cybersecurity requirements for the first component may include controls, requirements and policies for securing the first component (e.g., software or hardware device) or securing operations performed by the first component.

In some examples, in step 708, the one or more processors determines whether the first component is in compliance with the security standard based on the comparison of the information contained in the one or more messages from the first component with corresponding cybersecurity requirements of the security standard. For example, one of requirements of a STIG standard may require the first component (e.g., application 120) to enforce a minimum of 14-character password length. Accordingly, the one or more processors determines whether the first component is in compliance with the security requirement by evaluating the information in the one or more messages from first component to determine password requirement implemented by the first component.

In some examples, the one or more processors may further obtain messages from a second component (e.g., application 220) while the second component is operating in a protected execution environment created by applying cybersecurity requirements of the security standard. The obtained one or more messages were encrypted by the second component using a predefined authentication scheme. As discussed in step 704, the one or more processors decrypts the one or more messages using the predefined authentication scheme. In addition, the one or more processors may compare the information contained in the one or more messages from the second component with corresponding cybersecurity requirements of the security standard for the second component. The one or more processors may determine whether the second component is in compliance with the security standard based on the comparing of the information contained in the one more messages with corresponding cybersecurity requirements of the security standard.

In some examples, the one or more processors may create a block that includes determination of compliance of the first component and the second component. Further, the one or more processors may submit the block to a blockchain within the client computing environment. In the above example, the blockchain stores an immutable record of compliance for one or more components using one or more blocks.

In some examples, the one or more processors may create a block that includes determination of compliance of the first component and the second component. Further, the one or more processors may submit the block to a blockchain outside the client computing environment. In the above example, the blockchain stores an immutable record of compliance for one or more components using one or more blocks.

In some examples, the one or more processors may create a block that includes determination of compliance of the first component. Further, the one or more processors may submit the block to a first blockchain associated with the first component, wherein the first blockchain stores an immutable record of security standard compliance for one or more components within the client computing environment. In addition, the one or more processors may submit the block to a second blockchain outside the client computing environment, wherein the second blockchain stores an immutable record of security standard compliance for one or more components.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A computer-implemented method for cybersecurity validation, the method comprising:
obtaining one or more messages from a first component while the first component is operating in a protected execution environment created by applying cybersecurity requirements of a security standard, wherein the one or more messages include information about the cybersecurity requirements, and wherein the obtained one or more messages were encrypted by the first component;
decrypting the one or more messages;
comparing the information contained in the one more messages with corresponding cybersecurity requirements of the security standard for the first component; and
determining whether the first component is in compliance with the security standard based on the comparing of the information contained in the one more messages with corresponding cybersecurity requirements of the security standard.

2. The computer-implemented method of claim 1, wherein the one or more messages are beacon messages.

3. The computer-implemented method of claim 2, wherein the beacon messages are emitted from the first component on a predefined schedule without being prompted.

4. The computer-implemented method of claim 1, wherein the security standard is a Security Technical Implementation Guide (STIG).

5. The computer-implemented method of claim 1, wherein the one or more messages are emitted by the first component as a result of executing microcode while performing one or more operations at the first component.

6. The computer-implemented method of claim 5, wherein the microcode was installed on the first component prior to creation of the protected execution environment.

7. The computer-implemented method of claim 1, wherein the first component is at least one of an operating system, a software application, or a programmable hardware.

8. The computer-implemented method of claim 1, further comprises:
obtaining one or more messages from a second component while the second component is operating in a protected execution environment created by applying cybersecurity requirements of the security standard, wherein the one or more messages include information about the cybersecurity requirements, and wherein the obtained one or more messages were encrypted by the second component;
decrypting the one or more messages from the second component;
comparing the information contained in the one more messages from the second component with corresponding cybersecurity requirements of the security standard for the second component; and
determining whether the second component is in compliance with the security standard based on the comparing of the information contained in the one more messages with corresponding cybersecurity requirements of the security standard.

9. The computer-implemented method of claim 8, further comprises:
creating a block including determination of compliance of the first component and the second component; and
submitting the block to a blockchain, wherein the blockchain stores an immutable record of compliance for one or more components using one or more blocks.

10. The computer-implemented method of claim 1, further comprises:
creating a block including determination of compliance of the first component;
submitting the block to a first blockchain associated with the first component, wherein the first blockchain stores an immutable record of security standard compliance for one or more components within the client computing environment; and
submitting the block to a second blockchain, wherein the second blockchain stores an immutable record of security standard compliance for one or more components.

11. The computer-implemented method of claim 1, further comprises:
updating microcode upon identifying a change to the security standard for the first component.

12. A non-transitory computer-readable storage medium storing instructions configured to be executed by one or more processors of an electronic device for cybersecurity validation, comprising instructions for:
obtaining one or more messages from a first component while the first component is operating in a protected execution environment created by applying cybersecurity requirements of a security standard, wherein the one or more messages include information about the cybersecurity requirements, and wherein the obtained one or more messages were encrypted by the first component;
decrypting the one or more messages;
comparing the information contained in the one more messages with corresponding cybersecurity requirements of the security standard for the first component; and
determining whether the first component is in compliance with the security standard based on the comparing of the information contained in the one more messages with corresponding cybersecurity requirements of the security standard.

13. The non-transitory computer-readable storage medium of claim 12, wherein the one or more messages are beacon messages.

14. The non-transitory computer-readable storage medium of claim 13, wherein the beacon messages are emitted from the first component on a predefined schedule without being prompted.

15. The non-transitory computer-readable storage medium of claim 12, wherein the security standard is a Security Technical Implementation Guide (STIG).

16. The non-transitory computer-readable storage medium of claim 12, wherein the one or more messages are emitted by the first component as a result of executing microcode while performing one or more operations at the first component.

17. The non-transitory computer-readable storage medium of claim 16, wherein the microcode was installed on the first component prior to creation of the protected execution environment.

18. The non-transitory computer-readable storage medium of claim 12, further comprising instructions for:
obtaining one or more messages from a second component while the second component is operating in a protected execution environment created by applying cybersecurity requirements of the security standard, wherein the one or more messages include information about the cybersecurity requirements of the second component, and wherein the obtained one or more messages were encrypted by the second component;
decrypting the one or more messages from the second component;
comparing the information contained in the one more messages from the second component with corresponding cybersecurity requirements of the security standard for the second component; and
determining whether the second component is in compliance with the security standard based on the comparing of the information contained in the one more messages with corresponding cybersecurity requirements of the security standard.

19. An electronic device, comprising:
one or more processors; and
memory storing one or more programs configured to be executed by the one or more processors, the one or more programs including instructions for:
obtaining one or more messages from a first component while the first component is operating in a protected execution environment created by applying cybersecurity requirements of a security standard, wherein the one or more messages include information about the cybersecurity requirements, and wherein the obtained one or more messages were encrypted by the first component;
decrypting the one or more messages;
comparing the information contained in the one more messages with corresponding cybersecurity requirements of the security standard for the first component; and
determining whether the first component is in compliance with the security standard based on the comparing of the information contained in the one more messages with corresponding cybersecurity requirements of the security standard.

20. The electronic device of claim 19, wherein the security standard is a Security Technical Implementation Guide (STIG).
